(19) United States
(12) Patent Application Publication
(10) Pub. No.: US 2013/0273639 A1
(43) Pub. Date: Oct. 17, 2013

(54) TREATMENT OF A SECTION OF A FLOW ENGINE

(71) Applicant: Ulf Nilsson, Whetstone (GB)

(72) Inventor: Ulf Nilsson, Whetstone (GB)

(21) Appl. No.: 13/858,980

(22) Filed: Apr. 9, 2013

(30) Foreign Application Priority Data
Apr. 16, 2012 (EP) 12164296.1

(51) Int. Cl. C11D 7/40

(52) U.S. Cl. CPC C11D 7/40
USPC 435/264

(57) ABSTRACT

A method that is provided that the at least one section of the flow engine includes at least a part of a combustion chamber of a gas turbine and is treated with at least a component with at least a biocatalytic activity, wherein the least one component with at least a biocatalytic activity is used for degradation of at least a substance with high hydrocarbon content, which is a carbonization arising during a combustion process. The invention further relates to a use of the at least one component with the at least one a biocatalytic activity for the treatment of the at least one section of the flow engine.

### CROSS REFERENCE TO RELATED APPLICATIONS

The present application claims priority to European Patent Office application No. 12164296 EP filed Apr. 16, 2012, the entire content of which is hereby incorporated herein by reference.

### FIELD OF INVENTION

The present invention relates to a method for a treatment of at least a section of a flow engine.

### ART BACKGROUND

In combustion chambers of gas turbines fuel is burned for generating thermal energy. The combustion chamber comprises a burner body with a pilot burner face, wherein the latter comprises a liquid fuel lance having a conduit for guiding the liquid fuel to a tip provided for injecting pilot fuel into the combustion chamber. Holes are provided in the tip for injecting cooling medium, which cools the lance tip and interacts with the fuel injected from the lance tip to create a homogeneous air/fuel mixture.

In order to achieve a combustion with low emissions, it is a need to achieve a high degree of atomization of the fuel in a main operating range. During a start-up phase and during low load operation of the gas turbine, a less distributed fuel spray with large droplets is generated, due to the reduced mass flow and pressure. This increases the tendency of the fuel for splashing and smearing and especially to deposit on the lance tip and the adjacent areas. During operation the fuel covered surfaces on the pilot burner surface may coke and carbonize, such that a hard and adhesive coating is generated. This process is driven by the heat from the combustion process. The coke and carbonization onto the pilot burner face may lead to a blockage of the holes for injecting the cooling medium. Hence, the temperature of the lance tip may increase and the fuel flow through the lance tip may ultimately stop if the fuel orifice of the lance tip is blocked by carbonized fuel. All this leads to poor start reliability and requires additional maintenance.

In order for the combustion system to regain its optimal performance the coke or carbonized deposits will need to be removed with regular intervals. Different methods are known and used in the removal process i.e. mechanical removal with mechanical tools such as rotating brushes, metal grinder or files, or liquid cleaning with various liquids such as acids. From US 2009/0293906 it is for example known to use an ultrasonic transducer in combination with a cleaning fluid to make the cleaning more effective. Disadvantageously, those methods either damage a base material of the burner body or the fuel nozzle or does not remove all of the deposits, which changes the spray characteristics and hence the combustion performance.

In other approaches, the critical surfaces of the elements of a gas turbine that are in contact with fuel are coated with high temperature alloys with a coke inhibiting layer.

### SUMMARY OF THE INVENTION

It is a first objective of the present invention to provide a method for a treatment of at least a section of a flow engine which provides good treatment results and is quick in its performance.

It is a further objective of the present invention to provide a use of at least a component with at least a biocatalytic activity for a treatment of at least the section of the flow engine.

These objectives may be solved by a method and use according to the subject-matter of the independent claims

According to a first aspect of the present invention, a method for a treatment of at least a section of a flow engine is presented.

It is provided, that the at least one section of the flow engine comprises at least a part of a combustion chamber of a gas turbine and is treated with at least a component with at least a biocatalytic activity, wherein the least one component with at least a biocatalytic activity is used for degradation of at least a substance with high hydrocarbon content, which is a carbonization arising during a combustion process. Due to the inventive matter an environmental friendly method can be provided. Moreover, it operates independently, especially from an external source, e.g. an operator or an energy source. It should be noted, that a supplying of a specific environment, like an adjusted or applied temperature, pressure, humidity, pH-value, salt-concentration, radiation (IR-, UV-, VIS-, X- or radioactive radiation) or similar should not be understood as external source. Further, the inventive method performs without a damage of the at least one component or the base material of the at least one component.

Further, due to the inventive matter a section which is highly affected by the treatment and/or habitually causes problems due to its high contamination during the combustion process can be treated efficiently and properly. Moreover, due to the ability of the at least one component with the at least one biocatalytic activity for degradation of at least a substance with high hydrocarbon content, an easy and effective method for disposing of a contaminating, surplus and/or undesired processing material, post-production material, such as lubricant residues, coating residues, fuel and/or deposited reaction products can be provided.

In this context a flow engine is intended to mean any engine or machine suitable for a person skilled in the art, e.g. a thermal heating plant, a gas turbine or an internal combustion engine. Furthermore, the phrase “for a treatment” should be understood as any possible treatment which is employable for a person skilled in the art, like a coating, finishing, deburring, dyeing, stripping, polishing, cleaning etc.

A “biocatalytic activity” is intended to mean the ability to transform, convert, process, digest, catabolise, metabolise or any other action suitable for a person skilled in the art, at least one material or substance by means of a biological mechanism or process. In this context a biological process is intended to mean a process which contributes to a function of a living unit, like a cell, a tissue, an organ or an organism. The effected material or substance could be any material suitable for a person skilled in the art, like a gas, a fluid or a solid material e.g. a ceramic, a polymer, a rubber, grease, an oil, an organic compound or composition etc.

A “component with at least a biocatalytic activity” may be a substance, a mixture of at least two substances, at least one organism and/or a combination of at least a substance and at least one organism, which possesses the at least one biocatalytic activity. Advantageously, the component is chosen from the group comprising of DNA, RNA, mRNA, siRNA, a peptide, a protein or an active fragment thereof, an enzyme or an active fragment thereof, an antibody or an active fragment thereof, a cell, a cell culture, a tissue, an organ, an organism, a prokaryote, an eukaryote, a protozoa, a metazoan, a microbe, a virus, a bacterium, an archaea, a fungus, an alga, an animal, a plant or the like. Moreover, the component may have more than one biocatalytic activity. Hence, at least two functions or even treatments could be facilitated with one component. In this context “degradation” is intended to mean a chemical decomposition or breakdown, where a separation of a chemical compound into elements or simpler compounds occurs.

In a preferred embodiment the at least one component with at least one biocatalytic activity is provided from at least a living organism. With this realisation the at least one component is easy to obtain. Furthermore, the living mechanism is able to operate the method self-acting and automatic. The term “provide” should be understood as “build, make, compose, generate and/or secrete”. The living organism may provide the at least one component with at least one biocatalytic activity in situ or beforehand of the treatment and in the latter case may be obtained, harvested or recovered in laboratory scale. Further, the living organism may be any living organism known to a person skilled in the art and can be e.g. , a prokaryote, an eukaryote, a protozoa, a metazoan, a microbe, a virus, a bacterium, an archaea, a fungus, an alga, an animal or a plant. It should be noted, that despite a virus is an infectious particle that can't live autarkic they are deliberately included in the scope of the invention for example due to their effects in combination with e.g. living organisms.

Advantageously, the at least one component with the at least one biocatalytic activity is provided from at least a microbe. Due to the easy breeding and harvesting of microbes the at least one component with the at least one biocatalytic activity can be obtained in large quantity in a big scale approach. The microbe may be any microbe known to a person skilled in the art and can be e.g. a virus, a bacterium, an archaea, a fungus, an alga, a protist, and microscopic plant, like green algae, or an animal, like plankton or planarian.

According to a further preferred embodiment the at least one component with the at least one biocatalytic activity is at least a living organism, like a microbe, a virus, a bacterium, an archaea, a fungus, an alga, an animal or a plant. Hence, the method for a treatment can be applied easily just by bringing together the living organism and the at least one section of the flow engine. Moreover, all characteristics of a living organism, like a capability of a response to stimuli, reproduction, growth, development and maintenance of homeostasis, can be advantageously exploited.

An especially easy to perform and applied method can be obtained, when the at least one component with the at least one biocatalytic activity is at least a microbe. Thus, due to for example an incubation of the at least one section of the flow engine with the microbe or advantageously a plurality of the same microbe the treatment can be easily implemented. The microbe may be a microbe that is known to ingest chemical energy from minerals or ancient carbon found for example in carbon-rich sources, like shale, rocks or volcanic rocks, respectively. These sources are e.g. sediments at the present the sea floor or at former ocean floors transformed now to formation above or slightly beneath (approx. 100 cm) the ground. Preferably, the microbe is a bacterium or an archaea. Due to the quick self-reproduction of these organisms, a sufficient quantity of treatment substance or the at least one component with the at least one biocatalytic activity may be gained or produced. Furthermore, these organisms have a modest need in maintenance and the space per organism they occupy is minimal, thus saving place during treatment or storage.

Growth, harvest, incubation, treatment conditions and/or the like beforehand and/or during the treatment of the at least one section of the flow engine, such as temperature, pressure, humidity, pH-value, salt-concentration or radiation, of all the aforementioned substances and/or organisms may be adjusted due to the used substance, organism and/or treatment. This will be accomplished by a person skilled in the art due to his knowledge independently.

In an advantageously embodiment of the invention just at least one active part/component of the at least one component with the at least one biocatalytic activity is use for the treatment of the at least one section of the flow engine. This may advantageously be a protein, a peptide, an enzyme and/or antibody or an active fragment thereof. Thus, by using only the at least one active part/component complex affords for live maintenance of the living organism may be omitted. Moreover, storage and handling of the at least one component with the at least one biocatalytic activity may be simplified.

Furthermore, preferably the at least one substance with high hydrocarbon content is built from at least a kerogen. Thus, during the combustion process arising contaminations, especially carbonization of the at least one section of the flow engine, can be eliminated efficiently with the inventive method. A kerogen is intended to mean any type of mixture of organic material (type I to type IV kerogen) of sapropelic, planktonic or humic origin.

In a further advantageous embodiment the at least one component with at least one biocatalytic activity is used for cleaning of the at least one section of the flow engine. Thus, contaminant can be removed easily as well as uncomplicated. Moreover, a polluted part of the flow engine needn't to be replaced by a new and clean one. Thus also is cost saving.

The problem of high contamination during the combustion process is particularly accentuated for gas turbines using dry low emissions (DLE). Furthermore, coking can also be experienced in other than DLE combustion systems operating with poor quality liquid fuels, e.g. specific types of diesel or heating oils. Problems potentially could also be experienced with gas fuels, i.e. coke oven gas or with heavy hydrocarbons. Thus, a reliability of a combustion chamber of such flow engines may be improved.

It is further provided, that the part of the combustion chamber of the gas turbine is a wall or face e.g. a side wall of a pre-chamber volume. Hence, a surface exposed to a volume or operation environment of the combustion chamber may be advantageously treaded or cleaned, respectively, with the inventive method.

Alternatively and/or additionally, the part of the combustion chamber of the gas turbine is advantageously a fuel injection device, thus the inventive method provides a treatment of a part of the combustion chamber which is highly affected and/or operationally subjected to high contamination during operation of the flow engine. Preferably, the fuel injection device is embodied as a fuel injection aperture.

In addition and/or alternatively the part of the combustion chamber of the gas turbine is an igniter device and/or at least advantageously comprises an igniter in a burner body. By means of the inventive method, a treatment of the part of the combustion chamber including an igniter tip of the igniter device is homogenous, because the inventive method provides equally access to all surfaces, even in angled configurations. Preferably, the igniter device is embodied as an igniter. The igniter device may use a fuel in a torch like embodiment e.g. a spark or plasma or laser to ignite the fuel air mixture. During operation the igniter may also over time experience build up of deposits requiring a treatment to regain its performance to reliably ignite the flame in the combustion chamber during the start sequence of the gas turbine.

According to a further exemplary embodiment the part of the combustion chamber of the gas turbine may be a pilot burner face of a burner body. Hence, clean result without damage of a base material of the burner body can be obtained.

Alternatively and/or additionally, the part of the combustion chamber of the gas turbine is advantageously a fluid nozzle and/or at least comprises a fluid nozzle in a burner body. Due to the inventive method, a treatment of the fluid nozzle and/or of the part of the combustion chamber including the fluid nozzle is homogenous, because the inventive method provides equally access to all surfaces, even in angled configurations. The term “fluid nozzle” should be understood as any injection device or aperture of the combustion chamber for any fluid feasible for a person skilled in the art, like a fuel and/or a cooling medium.

According to a further aspect of the present invention, a use of at least a component with at least a biocatalytic activity for a treatment of at least a section of a flow engine comprising at least a part of a combustion chamber of a gas turbine, wherein the at least one component with at least a biocatalytic activity is used for degradation of at least a substance with high hydrocarbon content, which is a carbonization arising during a combustion process is presented. Due to the inventive matter a use of an environmental friendly component can be applied. Furthermore, the use is independent, especially from an external source, e.g. an operator or an energy source. Further, the at least one component with at least one biocatalytic activity performs without a damage of the at least one component or the base material of the at least one component. Further, due to the inventive matter a section which is highly affected by the treatment and/or habitually causes problems due to its high contamination during the combustion process can be treated efficiently and properly. Furthermore, due to the ability of the at least one component with the at least one biocatalytic activity for degradation of at least a substance with high hydrocarbon content, an easy and effective method for disposing of a contaminating, surplus and/or undesired processing material, post-production material, such as lubricant residues, coating residues, fuel and/or deposited reaction products can be provided.

Moreover, the at least one component with the at least one biocatalytic activity may be applied to the at least one section of the flow engine with any method feasible for a person skilled in the art, e.g. exposing, coating, spraying or incubating/submerging in particular with/in a solution.

In a further advantageous realisation the at least one section of the flow engine is incubated in at least a solution containing at least the at least one component with the at least one biocatalytic activity. This action does favourably not require supervision. Moreover, due to the incubation in this solution the active component may have equally access to all surfaces, even in angled configurations, ensuring a homogenous treatment result. The treatment of the at least one section may include full submersion of the at least one section or partial submersion i.e. only exposing the surfaces showing the carbonization to the solution. In general, it would be also possible that the at least one section of the flow engine may be exposed in another way than (partly) submersion in the solution, like applying or spraying the at least one solution containing at least the at least one component with the at least one biocatalytic activity i.e. as a coating on the at least one section or on the carbonization.

In the following section the invention relevant main features of the flow engine or the gas turbine are briefly summarised.

The combustion chamber comprises at least a main combustion volume and a swirler device. A swirler of the swirler device is located upstream of the combustion volume. In an exemplary embodiment a pre-chamber guides the flow between the swirler and the main combustion volume.

Further, the combustion chamber comprises at least an injection device or aperture, respectively, such that fuel is injectable into the combustion chamber. In particular, a fuel injection aperture or hole is arranged in a pilot burner face of a burner body and injects the pilot fuel stream into the combustion chamber. The injection aperture may be arranged at a pilot tip of a fuel lance and may be provided with the fuel via a fuel conduit. Depending on the actual size or configuration of the pilot tip it may be preferable to have more than one fuel injection aperture and/or fuel conduit in the same pilot tip. The pilot tip may has a width (diameter) of more than approximately 3 mm, preferably more than approximately 5 mm and less than approximately 25 mm (Millimetres).

In addition, the combustion chamber comprises at least an igniter device such that the fuel air mixture is ignitable during start up. The ignition device may be an igniter or a conduit providing hot combustion gases from a neighbouring combustion chamber via a so-called cross ignition or cross lightning tube.

The fuel may be any fuel feasible for a person in the art, e.g. a gaseous fuel and/or a liquid fuel, like heating oil and/or diesel fuel, etc.

The combustion chamber or the pilot burner face, respectively, may additionally comprise an inlet channel with at least an inlet hole or preferably a plurality of inlet holes for injecting a cooling medium into the combustion chamber.

The inlet channel may have a width (diameter) of more than approximately 0.2 mm, preferably more than approximately 1 mm and less than approximately 10 mm (Millimetres).

The combustion chamber or the pilot burner face, respectively, may in addition for example have at least an inlet hole or preferably a plurality of inlet holes for injecting an additional fuel e.g. different fuel into the combustion chamber. The inlet holes may have a width (diameter) of more than approximately 0.2 mm, preferably more than approximately 0.5 mm and less than approximately 5 mm (Millimetres).

The inlet channel may be formed with a circular, elliptical, triangular, rectangular shape or a combination thereof, for example. Hence, the width may be defined by the hydraulic diameter i.e. the diameter of the circular shape, or the semiminor axis of an elliptical shape or the distance of opposed sides of a rectangular shape. The combination of the number of and dimension of the individual apertures can be selected to promote and control the fuel air mixing and the fuel distribution in the combustion chamber. The achievable time of operation between maintenance may depend on the location and dimension of the fluid aperture. Hence, by using such a larger inlet channel, the risk of completely blocking the inlet channel by coke or carbonized layers may be reduced.

The cooling medium in the combustion chamber may be, for example, air, steam, a gas fuel e.g. natural gas, a fluid, such as water, or other cooling fluids, which are suitable for cooling e.g. the pilot burner face. Preferably, a cooling medium is applied that cools the pilot burner face and particularly any fuel injection devices and is additionally usable for supporting the combustion inside the combustion chamber, such as an oxidant, e.g. air.

In particular, the inlet channel and the inlet holes, respectively, for injecting the cooling medium is/are placed close to the fuel injection aperture for generating a sufficient cooling energy for cooling the fuel injection aperture and the fuel lance. A plurality of injection channels for injecting the cooling medium is formed preferably around a circumferential direction along the fuel injection aperture.

The pilot burner face or a surface exposed to carbonized fuel is preferably alloyed with titanium or a titanium compound. Hence, since titanium is lesser reactive than other metal materials, such as steel or nickel, a clogging and an adhesion of carbonized fuel may be reduced.

The carbonization may have different causes. As described above, during start-up and low load operation fuel may carbonize onto surfaces of the combustion chamber. Moreover, most gas turbines are designed for so called dual fuel operation, wherein the main fuel is typically natural gas and a back up fuel, used when the main fuel is not available or low in supply, is typically a heating oil or kerosene. During operation it is possible to switch between the fuels without stopping the gas turbine. It may even be possible to continuously run on both fuels at the same time. In such a situation it may be an option to use natural gas instead of air to keep the lance tip cool. The gas fuel is cooler than the air from the compressor and would have a marginal impact on emissions particularly if traded off against the gas pilot fuel flow.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless otherwise notified, in addition to any combination of features belonging to one type of subject matter also any combination between features relating to different subject matters, in particular between features of the apparatus type claims and features of the method type claims is considered as to be disclosed with this application.

### BRIEF DESCRIPTION OF THE DRAWINGS

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

FIG. 1: shows a perspective schematic view of a section of a combustion chamber of a flow engine with a pilot burner face of a burner body which may be treated with a component with a biocatalytic activity according to the inventive method,

FIG. 2: shows a detailed schematic view of the pilot burner face from FIG. 1 with a fuel injection conduit surrounded by cooling medium injection holes,

FIG. 3: shows schematically the pilot burner face of FIG. 1 with carbonizations deposited in its surface,

FIG. 4: shows schematically and more detailed the carbonizations at an hole of an igniter of the pilot burner face and

FIG. 5: shows the pilot burner face from FIG. 1 contaminated with carbonizations and disassembled from the flow engine during the treatment with the component with a biocatalytic activity according to the inventive method.

### DETAILED DESCRIPTION

The illustrations in the drawings are schematically. It is noted that in different figures, similar or identical elements are provided with the same reference signs.

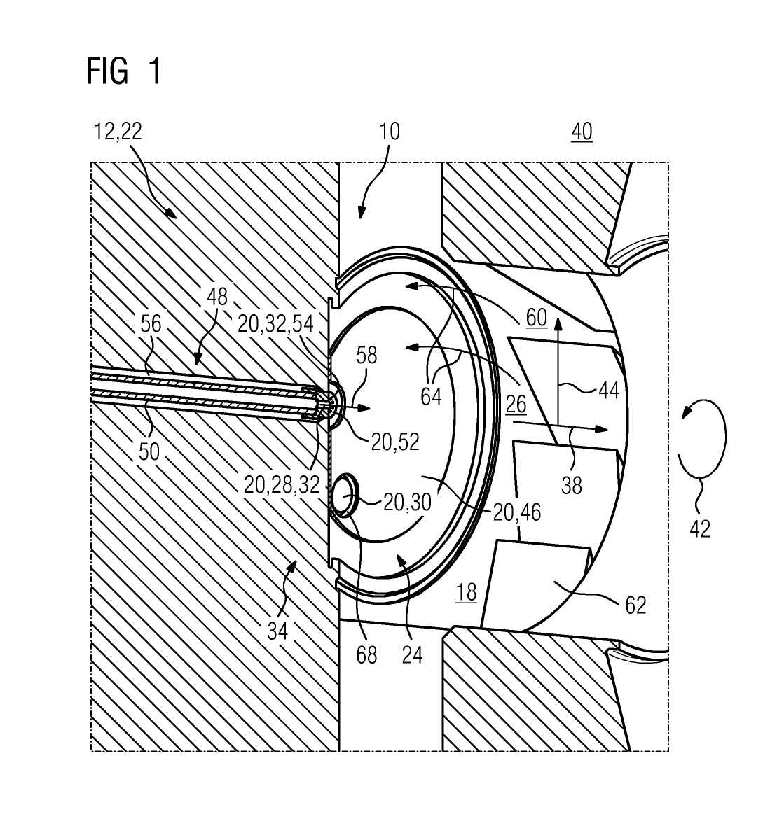

FIG. 1 shows a perspective view of a section 10 of a combustion chamber 18 of a not in detail shown flow engine 12 embodied as a gas turbine 22. The combustion chamber 18 is formed with a tubular-like shape (not shown in detail) which extends in axial direction 38 and comprises a pre-chamber volume 26 and a main chamber 40, wherein the latter extends in a circumferential direction 42 around the pre-chamber volume 26. Moreover, the combustion chamber 18 comprises a side wall 24, which extends basically in a direction 44 perpendicular to the axial direction 38 and is located axially adjacent to the pre-chamber volume 26. The side wall 24 is a part of a burner body 34 of the combustion chamber 18.

Further, the burner body 34 comprises as a part 20 of the combustion chamber 18 and the side wall 24 a pilot burner face 46, which is a section of a liquid fuel lance 48 that is inserted in the burner body 34. The liquid fuel lance 48 has a fuel conduit 50 for guiding a liquid or pilot fuel, like No. 2 heating oil, also known as diesel fuel, to a pilot or liquid fuel tip 52 for injection of the liquid fuel. Therefore, the pilot burner face 46, forming a part of the side wall 24, and hence the combustion chamber 18 comprises as a further part 20 of the combustion chamber 18 a fluid nozzle 32, which is embodied as the fuel injection device 28 or a fuel injection aperture.

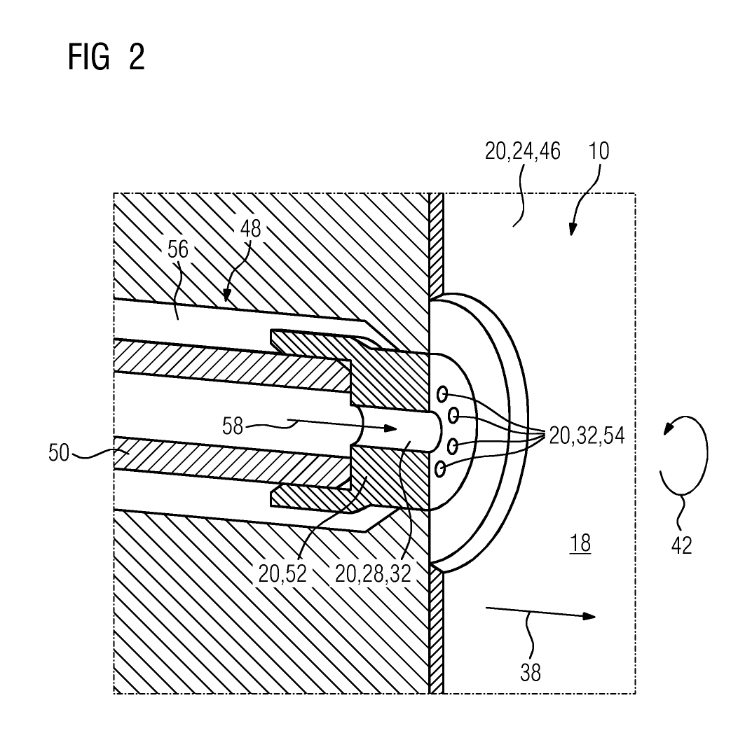

As shown in more detail in FIG. 2, the pilot burner face 46 or the liquid fuel tip 52, respectively, comprises as further fluid nozzles 28 several inlet holes 54 for injecting a cooling medium, e.g. air, from a cooling channel 56 extending basically in parallel to and in circumferential direction 42 around the fuel conduit 50 into the combustion chamber 18. The inlet holes 54 are formed circumferentially around the fuel injection device 28 or aperture as to promote the characteristics of the spray. The cooling medium is normally supplied from a compressor discharge of the gas turbine 22 utilizing the same available pressure drop as the main flow through the burner, however flowing in a parallel stream for the two flows to be joined in the burner cavity. Moreover, as a further part 20 of the combustion chamber 18 an igniter device comprising an igniter 30 is attached to the burner body 34 in order to ignite the injected fuel during start-up.

Through the fuel injection device 28 or aperture the pilot fuel is injected into the combustion chamber 18 in a predefined direction 58. The inlet holes 54 have a cross-section through which cooling medium is injected which interacts with the pilot fuel injected in the direction 58 through the fuel injection device 28 or aperture of the pilot burner face 46. The pilot burner face 46 may locally reach temperatures between approximately 800° C.-1000 C (Celsius) during operation. The inlet holes 54 for injecting cooling air cool the lance tip 52 and the injected cooling medium interacts with the fuel injected from the lance tip 52 to create a homogeneous air/fuel mixture.

An outer volume 60 of the combustion chamber 18, which extends in circumferential direction 42, comprises a swirler device, embodied as a swirler 62, wherein the swirler 62 is adapted for injecting a main fuel/air stream in circumferential direction 42 into the main chamber 40. The injected pilot liquid fuel and the injected cooling medium are injected for controlling the combustion of the main fuel/air mixture stream which flows through the swirler 62 of the combustion chamber 18.

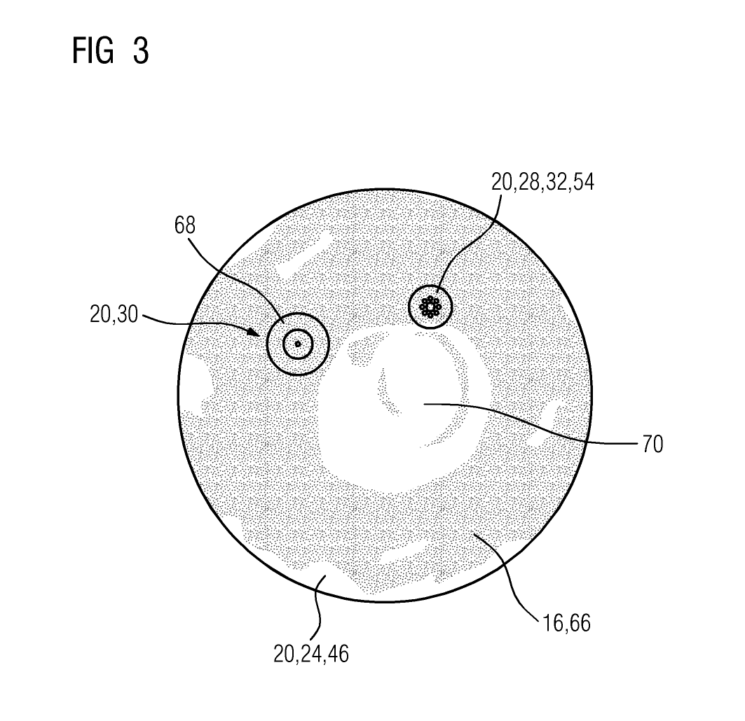

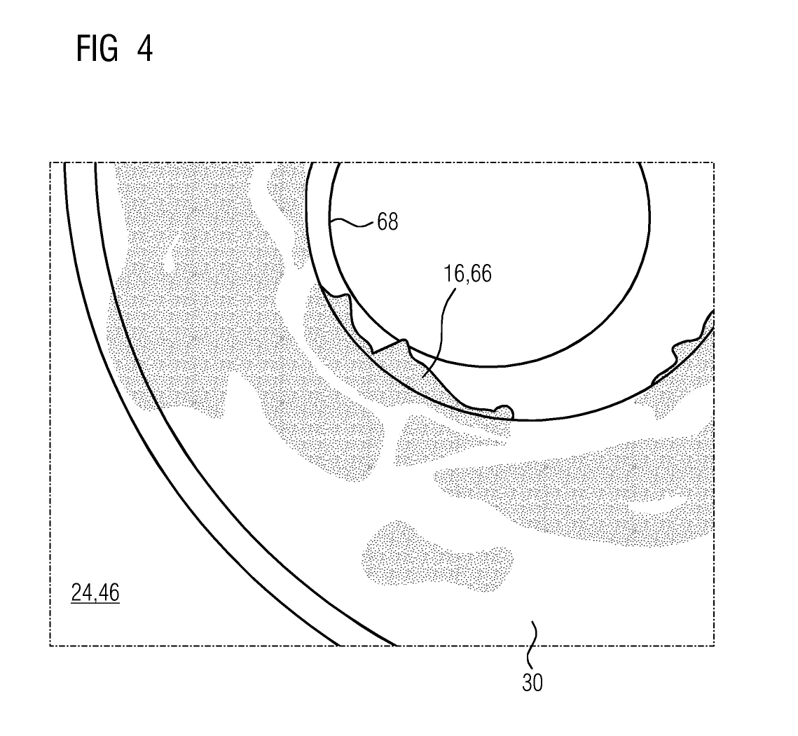

When the gas turbine 22 is running or during start up, i.e. when cooling air is delivered from a not shown compressor to the combustion chamber 18, the main acting force on the liquid fuel droplets inside the combustion chamber 18 is the flow field created by the swirler 62 in the combustion chamber 18. The flow field created by the swirler 62 forms a helical run of the fuel droplets along the axial direction 38 in the combustion chamber 18. The main fuel i.e. fuel air mixture stream 64 of the flow field containing the fuel droplets is indicated by the arrows printed in FIG. 1. The entered fuel may be deposited as a substance 16 with a high hydrocarbon content or out of a kerogen, respectively, and/or may carbonize as a carbonization 66 on parts 20 of the combustion chamber 18 e.g. in the pre-chamber volume 26, on the side wall 24, on the igniter 30, on the tip 52 and inside the inlet holes 54 or a hole 68 of the igniter 30 for the cooling medium due to the high temperature inside the combustion chamber 18 and thus may e.g. block the inlet holes 54. The deposited substance 16 will reduce the start reliability of the gas turbine 22 as well as the emission performance. In areas 70 where the surface temperature reaches sufficiently high levels during operation the fuel residuals will burn off, e.g. in the centre portion of the pilot burner face 46. This situation is schematically shown in FIGS. 3 and 4.

This substance 16 and/or carbonisation 66 can be removed by degradation with an inventive method for a treatment or a cleaning, respectively, of the section 10 of the flow engine 12 or the side wall 24 or the part 20 (pilot burner face 46 or a fuel nozzle 28 or the igniter 30) of the combustion chamber 18 (in the following text the terms section 10 of the flow engine 12 is used synonymously for the term part 20 of the combustion chamber 18). According to this method the section 10 of the flow engine 12 is treated with a component 14 with a biocatalytic activity. The component 14 with the biocatalytic activity, which metabolises or removes by degradation the high hydrocarbon content and/or the kerogens of the substance 16 and/or carbonization 66, is a microbe and thus a living organism. Generally, it is also possible, that the component 14 is provided from a microbe or a living organism, respectively, and may be, for example, an enzyme of the microbe metabolising or removing by degradation the high hydrocarbon content and/or the kerogens of the substance 16.

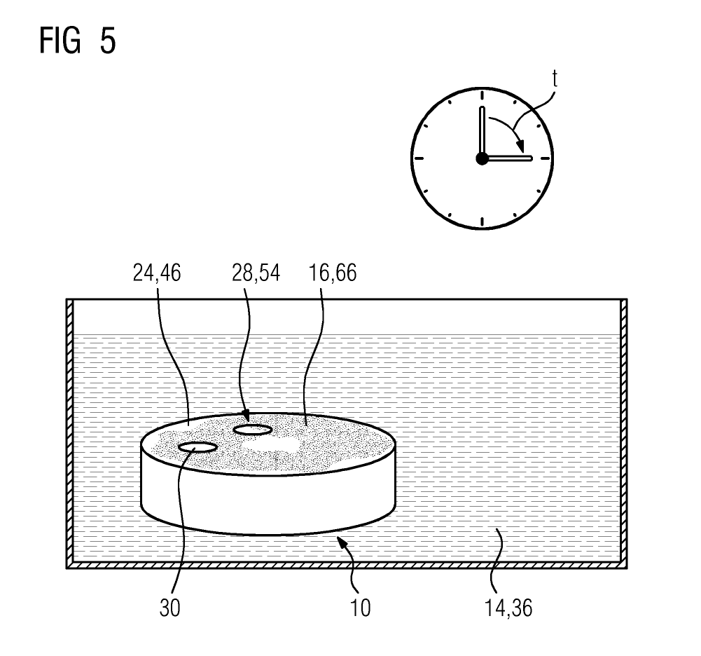

Therefore, the component 14 with the biocatalytic activity is used for the treatment of the section 10 of a flow engine 12 and specifically by incubating the section 10 in a solution 36, which contains the component 14 with the biocatalytic activity. This can be seen in FIG. 5 that shows schematically the pilot burner face 46 with the fluid nozzles 28 and the igniter 30 contaminated with the substance 16 and disassembled from the flow engine 12 during the treatment with the component 14 with a biocatalytic activity according to the inventive method. The incubation time t will be adjusted in a way so that the carbonization 66 will be completely removed. The treatment of the section 10 may include full submersion of the section 10 or partial submersion i.e. only exposing the surfaces showing the carbonization 66 to the solution 36.

In FIG. 5 a dissembled burner face gets the treatment by the component 14. In other arrangements component 14 may be injected into an assembled gas turbine combustion chamber such that it able to affect the carbonized surfaces in a still assembled burner within the combustion chamber. For this, for example, a cap is placed over the burner face such that the component 14 will be encapsuled by the burner face and surfaces of the cap. The component 14 then can affect the burner face.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

Although the invention is illustrated and described in detail by the preferred embodiments, the invention is not limited by the examples disclosed, and other variations can be derived therefrom by a person skilled in the art without departing from the scope of the invention.

1. A method for a treatment of a section of a flow engine, the section of the flow engine comprises a part of a combustion chamber of a gas turbine, comprising:
treating the section of the flow engine with a component which includes a biocatalytic activity,
wherein the component which includes the biocatalytic activity is used for degradation of a substance with high hydrocarbon content, which is a carbonization (66) arising during a combustion process.

2. The method according to claim 1,
wherein the component which includes the biocatalytic activity is provided from at least a living organism.

3. The method according to claim 1,
wherein the component which includes the biocatalytic activity is provided from at least a microbe.

4. The method according to claim 1,
wherein the component which includes the biocatalytic activity is at least a living organism.

5. The method according to claim 1,
wherein the component which includes the biocatalytic activity is at least a microbe.

6. The method according to claim 1,
wherein the substance with high hydrocarbon content is built a kerogen.

7. The method according to claim 1,
wherein the component with the at least one biocatalytic activity is used for cleaning of the section of the flow engine.

8. The method according to claim 1,
wherein the part of the combustion chamber of the gas turbine is a side wall of a pre-chamber volume.

9. The method according to claim 1,
wherein the part of the combustion chamber of the gas turbine is a fuel injection device.

10. The method according to claim 1,
wherein the part of the combustion chamber of the gas turbine is an igniter.

11. The method according to claim 1
wherein the part of the combustion chamber of the gas turbine is a fluid nozzle of a burner body.

12. The method according to claim 1
incubating the section in a solution comprising the component which includes the biocatalytic activity.
